(19) United States
(12) Patent Application Publication
(10) Pub. No.: US 2023/0150576 A1
(43) Pub. Date: May 18, 2023

(54) DETECTION UNIT FOR DETECTING AN EXCEEDANCE OF A PREDEFINED MAXIMUM STEERING ANGLE, STEERING DEVICE, STEERING SYSTEM, AND METHOD USING SAME

(71) Applicant: ZF Automotive Germany GmbH, Alfdorf (DE)

(72) Inventor: Richard Büker, Willich (DE)

(73) Assignee: ZF Automotive Germany GmbH, Alfdorf (DE)

(21) Appl. No.: 17/983,507

(22) Filed: Nov. 9, 2022

(30) Foreign Application Priority Data
Nov. 15, 2021 (DE) 102021212793.2

(51) Int. Cl. B62D 15/02

(52) U.S. Cl. CPC B62D 15/022

(57) ABSTRACT

The disclosure relates to a detection unit for detecting an exceedance of a predefined maximum steering angle of a steering device, with a trigger unit and with a signal transmitting section, wherein, upon an exceedance of the predefined maximum steering angle, the trigger unit changes the signal transmitting section with respect to the transmission of a signal.

### CROSS-REFERENCE TO RELATED APPLICATION

This application claims priority to German Priority Application No. 102021212793.2, filed Nov. 15, 2021, the disclosure of which is incorporated herein by reference in its entirety.

### TECHNICAL FIELD

The disclosure relates to a detection unit for detecting an exceedance of a predefined maximum steering angle of a steering device. The disclosure also relates to a steering device with a detection unit of this type and to a steer-by-wire steering system with a steering device of this type. Finally, the disclosure relates to a method for detecting an exceedance of a predefined maximum steering angle.

### BACKGROUND

In a steer-by-wire steering system in particular, there is no mechanical connection between a steering wheel and a steering gear. Therefore, steering commands are transmitted to an electric motor by a control unit. The electric motor, using the steering gear, displaces a rack to steer the wheels. The rack can adjust a steering angle at the wheels by tie rods. In one exemplary arrangement, the steering device has a feedback motor, which simulates steering forces, in order to give the driver a feedback on the acting steering forces.

In a conventional steering system with a mechanical connection between the steering wheel and the rack, the steering angle of a steering wheel is limited due to the predefined mechanics. Due to the absence of a mechanical connection between the steering device and the steering gear in a steer-by-wire steering system, it would be possible, by comparison, to endlessly turn the steering wheel in one direction of rotation. As a result, there is a risk, however, of overloading or damaging integral parts of the steering device. For example, a winding element functioning as an electrical line or a clock spring for operating an airbag upon an exceedance of the predefined maximum steering angle can become damaged, as the result of which there is a risk that the airbag is no longer operable.

DE 10 2018 218 484 A1 describes a steering device, which has a mechanical end stop unit for delimiting the steering angle.

It is also known that a steering device, due to, for example, the feedback motor, generates a resistance that is noticeable and/or increased for a user, in order to make an attainment of the predefined maximum steering angle noticeable. In this connection, the feedback motor can provide a torque, which counteracts a rotary motion caused by the user. A mechanical end stop unit can be dispensed with in this case. There is a risk, however, that the user overcomes the counteracting torque of the feedback motor with a sufficient force and the predefined maximum steering angle is exceeded.

In the case of a non-activated steering device and/or a non-activated feedback motor, for example in the case of a dead steering device and/or a dead feedback motor, a shaft of the steering device and/or a steering wheel of the steering device can be rotatable freely or essentially without resistance. As a result, there is a risk that an attainment of the predefined maximum steering angle is not noticeable by the user and the predefined maximum steering angle is exceeded without this being noticed. This can result in undesirable damage.

### SUMMARY

The problem addressed by the disclosure is to further develop a detection unit, a steering device, a steer-by-wire steering system, and/or a method of the type mentioned at the outset in such a way that an exceedance of the predefined maximum steering angle is reliably detected. In one exemplary arrangement, an alternative arrangement is to be provided.

The detection unit according to the disclosure is designed for detecting an exceedance of a predefined maximum steering angle of a steering device. In one exemplary arrangement, a maximum rotary motion of a shaft of the steering device in two opposite directions of rotation is predefined due to the predefined maximum steering angle. The shaft of the steering device and/or a steering wheel connected to the shaft are/is moved only within a predefined angular range. For example, the predefined maximum steering angle starting from a zero position is less than 550 °. For example, the predefined maximum steering angle can have an absolute value of ± 550 ° or ± 510 ° or ± 360 ° or ± 170 °.

Within the scope of this application, the term “steering wheel” is a synonym for a steering handle of any shape and/or configuration. The steering wheel can be rotationally fixed and/or coupled to the shaft of the steering device. The shaft can be designed or designated as a steering shaft. Moreover, the shaft can be formed as one piece or multiple pieces.

The detection unit has a trigger unit and a signal transmitting section. The trigger unit is designed in such a way that, upon an exceedance of the predefined maximum steering angle, the trigger unit changes the signal transmitting section with respect to the transmission of a signal. In one exemplary arrangement, the signal transmitting section is changed with respect to the transmission of the signal by the trigger unit due to an exceedance of the predefined maximum steering angle.

It is advantageous in this case that an exceedance of the predefined maximum steering angle is also detectable in the absence of a mechanical end stop unit or before an end stop unit has been impacted. A change of the signal transmitting section that has taken place can be detected, for example electronically, by an evaluation unit. In one exemplary arrangement, the change of the signal transmitting section takes place purely mechanically. Therefore, the trigger unit can be actuatable or actuated due to a rotation of a shaft of the steering device, for example by a user. If the predefined maximum steering angle is exceeded, the actuated trigger unit causes a mechanically triggered change of the signal transmitting section. In one exemplary arrangement, an over-rotation of a steering wheel or of a shaft of the steering device beyond the predefined maximum steering angle is also detectable when this has taken place in combination with a non-activated or dead steering device and/or a non-activated or dead feedback motor. in one exemplary arrangement, a change of the signal transmitting section that has already taken place is detectable after an activation of the steering device and/or of the feedback motor and/or of the evaluation unit.

The signal transmitting section can be designated or designed as a signal path for transmitting the signal. Depending on the signal that is utilized, the signal transmitting section can be designed as a material line or as a free space or an air chamber.

The change of the signal transmitting section can be an interruption and/or a severing of the signal transmitting section. Therefore, due to the change, the signal transmitting section can have been or will be transferred from a signal-conducting state into a signal-blocking state. For example, due to the change, a contact can have been or will be, for example, permanently, separated or a switch can have been or will be, for example permanently, opened.

Alternatively, the change of the signal transmitting section can be a closure of the signal transmitting section. In this case, due to the change, the signal transmitting section can have been or will be transferred from a signal-blocking state into a signal-conducting state. For example, a closing or a closure of the signal transmitting section can be understood to mean that the signal transmitting section has been or will be released for transmitting the signal. For example, a contact or a switch can have been or will be, for example permanently, closed due to the change.

According to another exemplary arrangement, the change of the signal transmitting section can cause a change of the signal itself that is directed or transmitted along the signal transmitting section. For example, a change of the signal transmitting section and of the transmitted signal itself can result due to a change in position of the trigger unit. The change in position can be detected by a light barrier.

The signal can be an electrical signal or a magnetic signal or an electromagnetic signal. For example, the signal can be designed as an electric current or as a magnetic field or as a light signal.

According to one exemplary refinement, the signal transmitting section is irreversibly interrupted or closed or changed after the exceedance of the predefined maximum steering angle. In other words, the signal transmitting section is non-reversibly or permanently interrupted or closed or changed after the exceedance of the predefined maximum steering angle. In one exemplary arrangement, the signal transmitting section is severed due to an interaction with the trigger unit upon exceedance of the predefined maximum steering angle. Upon exceedance of the predefined maximum steering angle, the trigger unit can effectuate a mechanical change, for example an interruption or severing or closure, of the signal transmitting section. In one exemplary arrangement, a stay in the workshop is necessary for an appropriately equipped motor vehicle to repair the severed, closed, or changed signal transmitting section and/or the detection unit. It can be necessary to replace the signal transmitting section, the detection unit, and/or the steering device to repair the interrupted, closed, or changed signal transmitting section.

According to another exemplary arrangement, the signal transmitting section is reversibly interrupted or closed or changed after the exceedance of the predefined maximum steering angle. In this exemplary arrangement, the change, for example the interruption or closure, of the signal transmitting section is therefore reversible or cancellable. Thus, the change of the signal transmitting section can be undone. In one exemplary arrangement, a replacement of the signal transmitting section, of the detection unit, and/or of the steering device is avoidable. The change, interruption, or closure of the signal transmitting section can be cancelled by a suitably designed mechanical or electromechanical or electronic reset unit. In one exemplary arrangement, the cancellation of the change of the signal transmitting section is not achievable by a restart or by the user of a motor vehicle equipped with the detection unit. In one exemplary arrangement, the cancellation of the change of the signal transmitting section is implementable within the framework of a workshop visit or a vehicle service in a workshop.

According to one exemplary arrangement, the signal transmitting section is designed as an electrical line section. The electrical conductivity of a signal transmitting section of this type can be easily monitored by means of a suitably designed evaluation unit. An interruption of the electrical line section can also be detected in an easy way. In one exemplary arrangement, the signal transmitting section is designed as a predetermined breakage point upon an exceedance of the predefined maximum steering angle or the signal transmitting section has a predetermined breakage point of this type. In this connection, the trigger unit can effectuate a severing, cutting, ripping-off, or tearing in two of the signal transmitting section, for example at the predetermined breakage point. The signal transmitting section can be formed by an electrical conducting wire or by an electrical conduction band.

According to another exemplary arrangement, the trigger unit includes a rotation element, which is directly or indirectly connectable to a shaft of the steering device. A rotary motion of the shaft about a central longitudinal axis of the shaft effectuates a rotation of the rotation element. For example, the rotation element is designed as a gearwheel. The shaft can be connected to a steering wheel. If a user turns the steering wheel, the shaft is set into a rotary motion about its central longitudinal axis. Due to the connection to the rotation element, the rotation element is simultaneously set into rotation about a rotation axis of the rotation element.

In one exemplary arrangement, the trigger unit has a contour section. This contour section is designed to effectuate the change in the configuration of an interruption of the signal transmitting section upon exceedance of the predefined maximum steering angle. For example, the contour section is movable due to a rotary motion of the shaft of the steering device. Therefore, a rotary motion of the shaft always also effectuates a movement of the contour section.

According to one exemplary arrangement, the contour section is arranged at the rotation element in a rotationally fixed manner. The contour section can be designed as a one-piece integral part of the rotation element. Alternatively, the contour section can be fastened at the rotation element as a standalone component. Due to the rotationally fixed arrangement of the contour section at the rotation element, the contour section, together with the rotation element, is set into rotation about the rotation axis of the rotation element during a rotary motion of the shaft of the steering device. The contour section can be designed as a projection. For example, the contour section is designed as a wedge-like projection. The contour section can have at least one wedge surface or two wedge surfaces facing away from each other. At least one wedge surface permits a type of cutting edge to be formed, which facilitates or supports the interruption of the signal transmitting section.

In one exemplary arrangement, the contour section is arranged on a lateral face of the rotation element. The lateral face can extend at a right angle to a central longitudinal axis of the shaft or a rotation axis of the rotation element.

According to another exemplary arrangement, a signal transmitting unit includes the signal transmitting section. Therefore, the detection unit can include the trigger unit and the signal transmitting unit, wherein the trigger unit and the signal transmitting unit interact to detect the exceedance of the predefined maximum steering angle.

The signal transmitting unit can include a mount. The mount can have or hold the signal transmitting unit for interacting with the trigger unit. For example, the mount holds the signal transmitting section for interacting with the contour section at the rotation element of the trigger unit. In one exemplary arrangement, the mount can have a generally U-shaped configuration. The signal transmitting section can extend between the two legs of the U-shaped mount. In one exemplary arrangement, the signal transmitting section extends transversely to the lateral face of the rotation element and/or in parallel to the central longitudinal axis of the shaft or in parallel to the rotation axis of the rotation element. Upon exceedance of the predefined maximum steering angle, the contour section can pass through a space between the two legs of the U-shaped mount, as the result of which the signal transmitting section is severed. As a result, an interruption of the signal transmitting section is achievable in a simple and effective way.

According to another exemplary arrangement, a sensor unit includes the detection unit for detecting the steering angle and/or a steering torque. Additionally, such a sensor unit can be designed for detecting a steering torque. Therefore, the detection unit can be integrated into a sensor unit that is already present in a motor vehicle. As a result, the need for additional installation space for the detection unit is reduced. In one exemplary arrangement, a rotation element of the trigger unit designed as a gearwheel is connected to a transmission or at least to one gearwheel of the sensor unit. In one exemplary arrangement, the transmission or the at least one gearwheel of the sensor unit is directly or indirectly connected to the shaft of the steering device. The rotation element of the trigger unit can be connected, via an intermediate connection of a toothed gear, to the transmission or to the at least one gearwheel of the sensor unit.

According to an alternative exemplary arrangement, the trigger unit has a winding element. The winding element is directly or indirectly connectable and/or connected to the shaft of the steering device. A rotary motion of the shaft about the central longitudinal axis of the shaft effectuates a winding movement of the winding element. The winding element can be designed as a clock spring and/or as an electrical conduction band. In particular, the winding element is spiral-shaped. In one exemplary arrangement, the winding element is an electrical line section for operating an airbag. Therefore, the winding element can perform a dual function. On the one hand, the winding element is utilized as an electrical line section for operating an airbag. Simultaneously, the winding element is an integral part of the trigger unit and, thereby, a part of the detection unit for detecting an exceedance of the predefined maximum steering angle.

According to one exemplary arrangement, the winding element includes the signal transmitting section or is connected to the signal transmitting section. For example, a change of the winding element, due to an at least partial winding or unwinding of the winding element, or a ripping-off of the winding element from the signal transmitting section, or a tearing in two of the winding element or of the signal transmitting section upon exceedance of the predefined maximum steering angle, effectuates the change or interruption of the signal transmitting section. Therefore, essential functionalities of the detection unit can be achieved by the winding element.

In one exemplary arrangement, the signal transmitting section is connected to an evaluation unit for detecting the change of the signal transmitting section. For example, the evaluating unit is designed for forwarding a warning signal to a user interface. The user interface can be a display and/or a fault memory of a motor vehicle equipped with the detection unit. A user of a motor vehicle is prompted via a display to visit a workshop.

A steering device with a detection unit according to the disclosure is advantageous, wherein the steering device includes a shaft, which is rotatable about its central longitudinal axis in two opposite directions of rotation. A rotation element or a winding element of the trigger unit is directly or indirectly connected to the shaft. A rotary motion of the shaft about the central longitudinal axis of the shaft is converted into a rotation of the rotation element or into a winding movement of the winding element. The rotation element or the winding element effectuates a change of the signal transmitting section upon an exceedance of the predefined maximum steering angle. For example, the steering device is designed for a motor vehicle and/or for steering a motor vehicle. The steering device can include a feedback motor. The shaft can be set into the rotary motion about the central longitudinal axis of the shaft, via an intermediate connection of a transmission, and/or provide a controllable torque resistance by the feedback motor. As a result, the user or driver of a motor vehicle with a steering device of this type can be provided with feedback on the steering forces acting at the wheels. The feedback motor may be designed as an electric motor.

Moreover, a steer-by-wire steering system with a detection unit according to the disclosure or with a steering device according to the disclosure is advantageous. For example, the steer-by-wire steering system is refined according to the arrangements explained in conjunction with the steering device according to the disclosure and described here and/or the detection unit according to the disclosure.

Moreover, an advantageous method results for detecting an exceedance of the predefined maximum steering angle in the case of a steering device according to the disclosure, wherein the rotation element or winding element directly or indirectly connected to the shaft of the steering device is set into rotation or a winding movement when the shaft rotates about its central longitudinal axis. The signal transmitting section is changed or interrupted or closed by the rotation element or of the winding element upon an exceedance of the predefined maximum steering angle. For example, the method is refined according to the exemplary arrangement explained in conjunction with the steering device according to the disclosure and described here and/or the detection unit according to the disclosure.

### BRIEF DESCRIPTION OF DRAWINGS

The disclosure is explained in greater detail in the following reference to the figures. Identical reference characters refer to identical, similar, or functionally identical components or elements. Wherein:

FIG. 1 shows a perspective side view of a first steering device according to the disclosure,

FIG. 2 shows a perspective top view of a detection unit according to the disclosure for the steering device according to FIG. 1,

FIG. 3 shows a detail of a perspective top view of the detection unit according to the disclosure, according to FIG. 2,

FIG. 4 shows a detail of a perspective side view of the detection unit according to the disclosure, according to FIG. 3, and

FIG. 5 shows a detail of a perspective side view of another steering device according to the disclosure with a schematically represented other detection unit according to the disclosure.

### DETAILED DESCRIPTION

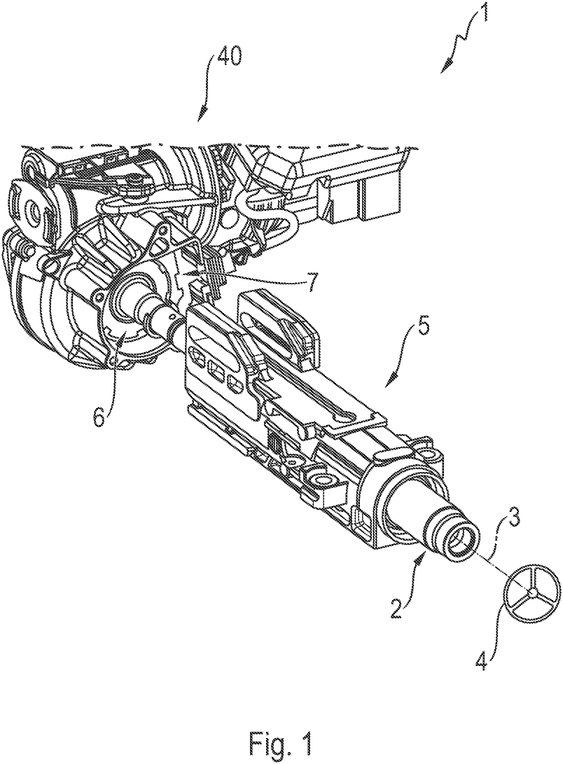

FIG. 1 shows a perspective side view of a steering device 1 according to the disclosure. The steering device 1 is an integral part of a steer-by-wire steering system, which is not represented here in greater detail. Here, the steering device 1 is provided and designed, for example, for a motor vehicle. The steering device 1 has a shaft 2. The shaft 2 is rotatable and mounted so as to be rotatable about its central longitudinal axis 3. The shaft 2 is connectable or connected to a steering wheel 4, which is merely schematically indicated here. Moreover, the shaft 2 is mounted so as to be rotatable within and in relation to a housing 5. The shaft 2 is rotatable about the central longitudinal axis 3, for example by the steering wheel 4, in two opposite directions of rotation.

The steering device 1 includes a feedback motor 40 in this case. An end of the shaft 2 facing away from the steering wheel 4 is connected to the feedback motor 40. The shaft 2 is drivable in a rotary motion about the central longitudinal axis 3 by the feedback motor 40. As a result, a controllable, torque resistance can be provided. Therefore, a user or driver of a motor vehicle with a steering device 1 of this type can be provided with feedback on the steering forces acting at the wheels. The feedback motor 40 is designed as an electric motor in this exemplary arrangement.

Moreover, the steering device 1 in this exemplary arrangement includes a sensor unit 6. The sensor unit 6 in this exemplary arrangement is arranged in the area of the feedback motor 40 and at an end of the shaft 2 facing away from the steering wheel 4. The sensor unit 6 is designed in this case, for example, for detecting a steering torque and a steering angle of the steering device 1. In this exemplary arrangement, the sensor unit 6 also includes a detection unit 7 for detecting an exceedance of a predefined maximum steering angle. The configuration and the mode of operation of the detection unit 7 are described in greater detail with reference to the following figures.

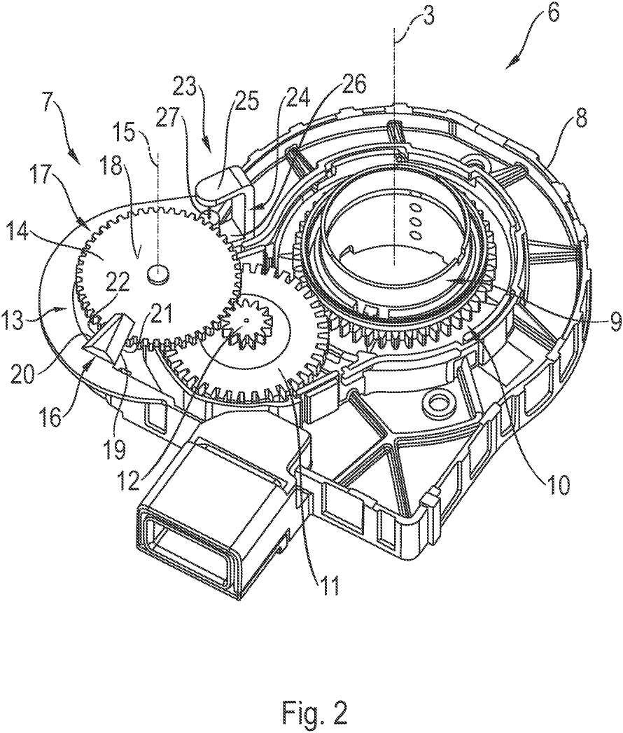

FIG. 2 shows a perspective top view of the detection unit 7 according to the disclosure. In this case, the detection unit 7 is accommodated, for example, in the sensor unit 6. The sensor unit 6 has a sensor housing 8 in which a hollow cylindrical sleeve 9 is mounted so as to be rotatable with respect to the sensor housing 8. In the assembled state according to FIG. 1, the shaft 2 extends through the sleeve 9. Here, the sleeve 9 is rotationally fixed to the shaft 2. Therefore, a rotary motion of the shaft 2 is transmitted onto the sleeve 9 and the sleeve 9 is moved and rotated together with the shaft 2. The sleeve 9 has an outer gear ring 10. The sensor unit 6 has a gearwheel 11, which engages into the gear ring 10. Therefore, the gearwheel 11 is likewise set into rotation when the sleeve 9 rotates. In this exemplary arrangement, a toothed gear 12 is rotationally fixed to the gearwheel 11. The axes of rotation of the gearwheel 11 and of the toothed gear 12 coincide in this exemplary arrangement. When the gearwheel 11 rotates, the toothed gear 12 therefore also rotates. In this exemplary arrangement, the toothed gear 12 has a smaller outer diameter than the gearwheel 11.

The detection unit 7 includes a trigger unit 13 in this exemplary arrangement. The trigger unit 13 has a rotation element 14. The rotation element 14 is designed as a gearwheel in this exemplary arrangement. The rotation element 14 designed as a gearwheel engages into the toothed gear 12. Therefore, due to a rotation of the toothed gear 12, the rotation element 14 is set into rotation about a rotation axis 15. The sleeve 9, the gear ring 10, the gearwheel 11, and the toothed gear 12, indirectly connects the rotation element 14 to the shaft 2 in the assembled state according to FIG. 1.

The trigger unit 13 has a contour section 16 in this exemplary arrangement. The contour section 16 is arranged at the rotation element 14 in a rotationally fixed manner. The contour section 16 projects radially, with respect to the rotation axis 15, outward beyond an edge 17 of the rotation element 14. The contour section 16 is arranged on a lateral face 18 of the rotation element 14. The lateral face 18 extends at a right angle to the central longitudinal axis 3 and at a right angle to the rotation axis 15 of the rotation element 14.

The projection-like contour section 16 is designed to be wedge-like in this exemplary arrangement. The contour section 16 has two wedge surfaces 19, 20 aligned facing away from each other in the circumferential direction with respect to the rotation element 14. Two cutting edges 21, 22 are formed by the wedge surfaces 19, 20 in this exemplary arrangement.

In this exemplary arrangement, the detection unit 7 includes a signal transmitting unit 23. The signal transmitting unit 23 has a mount 24. The mount 24 is fastened in a positionally fixed manner at the sensor unit 6 or at the sensor housing 8. In this exemplary arrangement, the mount 24 is designed in a U-shape. Two legs 25, 26 of the mount 24, which are spaced apart from each other and aligned in parallel to each other, extend in the direction of the rotation element 14 and the rotation axis 15. The legs 25, 26 are aligned at a right angle to the rotation axis 15 and to the central longitudinal axis 3 in this exemplary arrangement.

The mount 24 has a signal transmitting section 27 in this exemplary arrangement. The signal transmitting section 27 is designed as an electrical line section and implemented by an electrical conducting wire in this exemplary arrangement. The signal transmitting section 27 is held by the mount 24 for interacting with the trigger unit 13. The signal transmitting section 27 extends between the two legs 25, 26 at a right angle to the lateral face 18 of the rotation element 14 and in parallel to the central longitudinal axis 3 and in parallel to the rotation axis 15.

The edge 17 of the rotation element 14 is arranged approximately in the middle between the two legs 25, 26. The rotation element 14, the mount 24, and the signal transmitting section 27 are aligned with respect to one another such that the edge 17 and the rotation element 14 are spaced apart from the signal transmitting section 27.

The contour section 16 is designed and arranged such that, upon exceedance of a predefined maximum steering angle, the contour section 16 is guided between the two legs 25, 26 through the mount 24 and, thus, changes the signal transmitting section 27, namely severs the signal transmitting section 27 in this exemplary arrangement. This is described in greater detail with reference to the following figures.

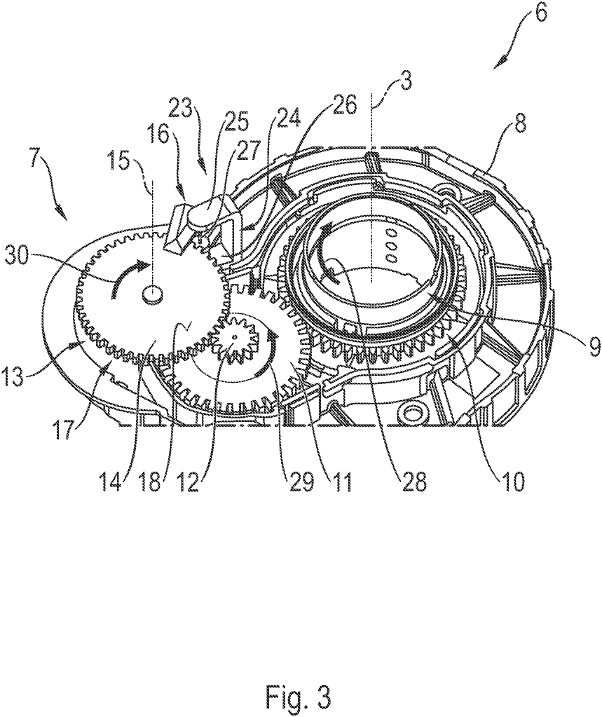

FIG. 3 shows a detail of a perspective top view of the detection unit 7 according to the disclosure, according to FIG. 2. Starting from a zero position of the detection unit 7 according to FIG. 2, the detection unit 7 according to FIG. 3 is shown in a position in which the predefined maximum steering angle has been reached and a further turning in the same direction of rotation represents an exceedance of the predefined maximum steering angle.

Starting from the zero position according to FIG. 2, the sleeve 9 is rotated in a first direction of rotation about the central longitudinal axis 3, for example, by means of the shaft 2 in the assembled state according to FIG. 1, according to the arrow 28. Due to the engagement of the gear ring 10 with the gearwheel 11, the gearwheel 11 and the toothed gear 12 are instantly set into rotation according to the arrow 29. Due to the engagement of the toothed gear 12 into the rotation element 14 designed as a gearwheel, this rotation element 14 is simultaneously rotated about the rotation axis 15 according to the arrow 30. As a result, the contour section 16 is simultaneously moved in the direction of the signal transmitting section 27. When the predefined maximum steering angle has been reached, the contour section 16 arrives between the two legs 25, 26 of the mount 24 and directly in front of the signal transmitting section 27.

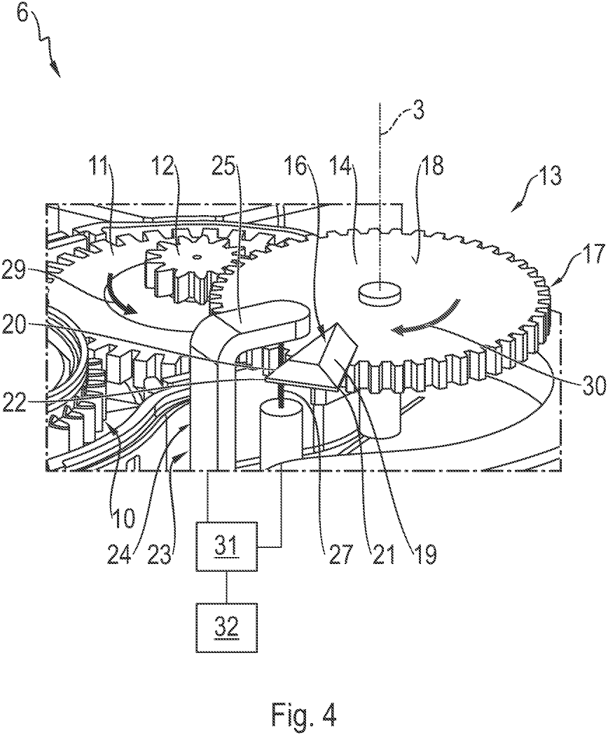

FIG. 4 shows a detail of a perspective side view of the detection unit 7 according to the disclosure, according to FIG. 3. If a rotary motion according to the arrow 30 continues beyond the predefined maximum steering angle, the contour section 16 passes through the area between the two legs 25, 26. The contour section 16 severs the signal transmitting section 27. As a result, the signal transmitting section 27 is interrupted. In order to detect this interruption of the signal transmitting section 27, the signal transmitting section 27 is connected to an evaluation unit 31, which is merely schematically indicated here. If an interruption of the signal transmitting section 27 is detected by the evaluating unit 31, the evaluation unit 31 forwards a warning signal to a user interface 32, which is merely schematically represented here. The user interface 32 can be a display in a dashboard of a motor vehicle and/or a fault memory that can be read out.

FIGS. 3 and 4 show the attainment of the predefined maximum steering angle in a first direction of rotation of the sleeve 9 and of the shaft 2 about the central longitudinal axis 3. Upon an exceedance of the predefined maximum steering angle, the signal transmitting section 27 is severed by the cutting edge 22 and the wedge surface 20 of the contour section 16. If the rotation element 14 moves in a second direction of rotation, which is opposite this first direction of rotation, and the associated predefined maximum steering angle is exceeded, the signal transmitting section 27 is severed in a similar way by the cutting edge 21 and the wedge surface 19.

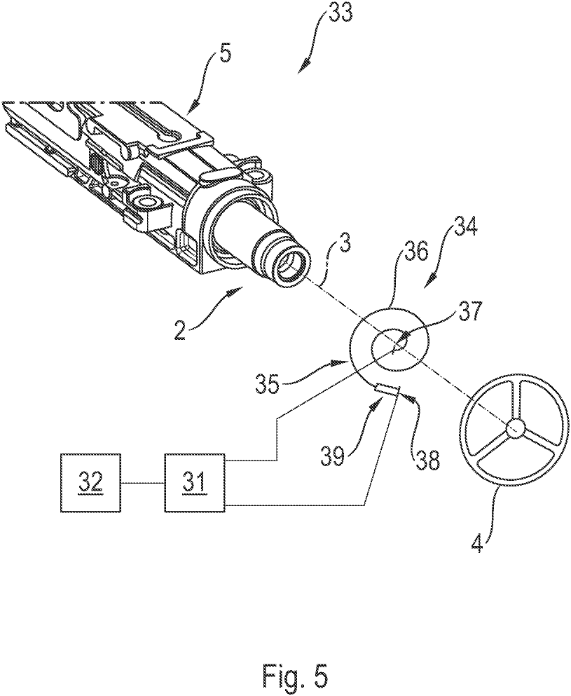

FIG. 5 shows a detail of a perspective side view of another steering device 33 according to the disclosure with another detection unit 34 according to the disclosure, which is merely schematically represented here. The steering device 33 essentially corresponds to the steering device 1. In this regard, reference is also made to the preceding description to avoid repetition. However, the steering device 33 includes the detection unit 34 instead of the detection unit 7.

In this exemplary arrangement, the detection unit 34 is assigned to an end of the shaft 2 facing the steering wheel 4. The detection unit 34 includes a trigger unit 35. The trigger unit 35 in this exemplary arrangement has a winding element 36. The winding element 36 is directly or indirectly connectable or connected to the shaft 2. In this exemplary arrangement, a first end 37 of the winding element 36 is connected to the shaft 2 in a manner not represented in greater detail. Therefore, the first end 37 is rotationally fixed to the shaft 2. As a result, when the shaft 2 rotates, the first end 37 rotates about the central longitudinal axis 3 along with the shaft 2. As a result, the winding element 36 is wound and unwound between two predefined maximum steering angles. The winding element 36 is essentially spiral-shaped in this exemplary arrangement. Moreover, the winding element 36 is designed here, for example, as a clock spring, which simultaneously provides an electrical conduction band. A second end 38 of the winding element 36, which faces away from the first end 37, is arranged and fastened at a housing section in a way not represented here in greater detail. The second end 38 is arranged in an immovable and positionally fixed manner with respect to the shaft 2 and the first end 37.

In this exemplary arrangement, the winding element 36 simultaneously also includes a signal transmitting section 39. In this case, the signal transmitting section 39 is assigned to the second end 38. Alternatively, the signal transmitting section 39 can also be arranged, however, at the first end 37 or at any point between the first end 37 and the second end 38.

The detection unit 34 and the winding element 36 are designed such that, upon an exceedance of the predefined maximum steering angle, the signal transmitting section 39 is torn in two and the winding element 36 is ripped off of the second end 38. As a result, the signal transmitting section 39 is interrupted, which is detected by the evaluation unit 31, which is merely schematically indicated here.

1. A detection unit for detecting an exceedance of a predefined maximum steering angle of a steering device, the detection unit comprising with-a trigger unit and a signal transmitting section, wherein, upon an exceedance of the predefined maximum steering angle, the trigger unit changes the signal transmitting section (27, 39) with respect to the transmission of a signal.

2. The detection unit as claimed in claim 1, wherein the signal transmitting section is irreversibly interrupted, closed, or changed after the exceedance of the predefined maximum steering angle.

3. The detection unit as claimed in claim 1, wherein the signal transmitting section is reversibly interrupted, closed, or changed after the exceedance of the predefined maximum steering angle, and wherein an interruption, closure, or change of the signal transmitting section is cancellable by a mechanical, electromechanical, or electronic reset unit.

4. The detection unit as claimed in claim 1, wherein the signal transmitting section is designed as a predetermined breakage point upon an exceedance of the predefined maximum steering angle, wherein the signal transmitting section is formed by an electrical conducting wire or by an electrical conduction band.

5. The detection unit as claimed in claim 1, wherein the trigger unit includes a rotation element operatively connectable to a shaft of the steering device, wherein a rotary motion of the shaft about a central longitudinal axis of the shaft effectuates a rotation of the rotation element.

6. The detection unit as claimed in claim 1, wherein the trigger unit has a contour section, wherein the contour section effectuates an interruption of the signal transmitting section upon exceedance of the predefined maximum steering angle.

7. The detection unit as claimed in claim 6, wherein the contour section is arranged at the rotation element in a rotationally fixed manner, wherein the contour section projects radially outward beyond an edge of the rotation element.

8. The detection unit as claimed in claim 5, wherein a signal transmitting unit includes the signal transmitting section, and the signal transmitting unit has a mount, which has or holds the signal transmitting section for interacting with the trigger unit.

9. The detection unit as claimed claim 1, wherein a sensor unit for detecting the steering angle and/or a steering torque includes the detection unit, and a rotation element of the trigger unit designed as a gearwheel is connected to a transmission or at least one gearwheel of the sensor unit, via an intermediate connection of a toothed gear.

10. The detection unit as claimed in claim 14, wherein the trigger unit includes a winding element, which is operatively connectable to a shaft of the steering device, wherein a rotary motion of the shaft about a central longitudinal axis of the shaft effectuates a winding movement of the winding element.

11. The detection unit as claimed in claim 10, wherein the winding element includes the signal transmitting section or is connected to the signal transmitting section, and wherein, a change of the winding element due to an at least partial winding or unwinding of the winding element, or a ripping-off of the winding element from the signal transmitting section or a tearing in two of the signal transmitting section upon exceedance of the predefined maximum steering angle, effectuates the change or an interruption of the signal transmitting section.

12. The detection unit as claimed in claim 1, wherein the signal transmitting section is connected to an evaluation unit for detecting the change of the signal transmitting section and for forwarding a warning signal to a user interface.

13. A steering device with a detection unit as claimed in claim 1, comprising a shaft, which is rotatable about its central longitudinal axis in two opposite directions of rotation, wherein a rotation element or a winding element of the trigger unit is directly or indirectly connected to the shaft, wherein a rotary motion of the shaft about the central longitudinal axis of the shaft effectuates a rotation of the rotation element or a winding movement of the winding element, and the rotation element or the winding element effectuates a change of the signal transmitting section upon an exceedance of the predefined maximum steering angle.

14. (canceled)

15. A method for detecting an exceedance of a predefined maximum steering angle of a steering device as claimed in claim 13, in which the rotation element or winding element, which is directly or indirectly connected to the shaft of the steering device, is set into a rotation or a winding movement during a rotary motion of the shaft about its central longitudinal axis, and the signal transmitting section is interrupted or closed or changed by the rotation element or the winding element upon an exceedance of the predefined maximum steering angle.

16. The detection unit as claimed in claim 1, wherein the signal transmitting section is severed due to an interaction with the trigger unit upon exceedance of the predefined maximum steering angle.

17. The detection unit as claimed in claim 6, wherein the contour section is movable due to a rotary motion of the shaft of the steering device.

18. The detection unit as claimed in claim 7, wherein the contour section is arranged on a lateral surface of the rotation element, wherein the lateral surface extends at a right angle to a central longitudinal axis of the shaft or of a rotation axis of the rotation element.

19. The detection unit as claimed in claim 8, wherein the signal transmitting section extends transversely to a lateral surface of the rotation element and/or in parallel to the central longitudinal axis of the shaft or in parallel to a rotation axis of the rotation element.
